(19) United States
(12) Patent Application Publication
(10) Pub. No.: US 2008/0288270 A1
(43) Pub. Date: Nov. 20, 2008

(54) System and method for generating an internet-based mall portal

(76) Inventor: Kevin Lee, New York, NY (US)

Correspondence Address: AMSTER, ROTHSTEIN & EBENSTEIN LLP, 90 PARK AVENUE, NEW YORK, NY, 10016, US

(21) Appl. No.: 11/804,524

(22) Filed: May 17, 2007

(51) Int. Cl. G06Q 30/00

(52) U.S. Cl. 705/1

(57) ABSTRACT

A method for providing a web-based mall portal for an affiliate that provides access to at least one of merchant web sites and service provider web sites through at least one of merchant information pages and service provider information pages, where the merchant information pages and the service provider pages are at least partially co-branded with the affiliate. In an exemplary embodiment, the method includes the steps of: receiving a request from the affiliate for a mall web site that provides access to the merchant web sites and the service provider web sites through the merchant information pages and the service provider information pages; generating the mall web site; providing the affiliate with administrative access to the mall web site; and providing credit to the affiliate for revenue generating activities conducted at the merchant web sites and service provider web sites as a result of access of the merchant web sites and service provider web sites though the merchant information pages and service provider information pages provided at the mall web site.

### FIELD OF THE INVENTION

The present invention relates to systems and methods for providing network services, and in particular to systems and methods for providing an Internet-based mall portal.

### BACKGROUND OF THE INVENTION

The concept of providing a web-based mall portal is known in the art. For example, www.mytriggers.com is a web-based mall portal that provides access through Internet links to a number of merchant and service provider web sites, such as Amazon.com, Dell.com and BestBuy.com. Such sites often include a list of merchants and service providers that can be accessed through the mall portal, and generally a mall site divides available services and merchandise up into categories and/or store names to allow customers easier navigation through the mall. Web based mall portals can be very profitable to the site owner (i.e., “affiliate”), since by providing access to a large number and variety of service providers and merchants, such malls have the potential to attract a wider range of potential customers browsing the Internet for a particular item or service.

Online mall portals earn revenue through placement of advertisement links on pages leading to merchants. Such revenue may be derived by, for example, sharing in transactions that occur after users follow links to merchant/service provider sites from the mall portal, receiving payment for every click leaving the mall through an advertising link placed within the mall, or receiving advertising revenue paid on a cost per thousand impressions (CPM) or sponsorship basis. In order to be approved by merchants and service providers to build and develop an online mall, one requires a significant amount of pre-existing site traffic, which becomes a barrier to entry, particularly for non-profit organizations, charities and small business entities wishing to become direct affiliates of the merchants and service providers.

Accordingly, there is a need for a system and method for generating a web-based mall portal that provides the advantages of conventional mall portals in providing a full selection of merchant store links and generating revenue for both the merchants/service providers accessible through the mall and the affiliate mall being used. Many potential affiliates do not have either the critical mass of traffic, nor do they have the resources to develop an Internet mall, posing two significant barriers to development of a successful mall portal.

### SUMMARY OF THE INVENTION

According to an exemplary embodiment of the present invention, a method for providing an Internet-based mall portal for an affiliate that provides access to at least one of merchant web sites and service provider web sites, where the merchant web sites and the service provider web sites are accessible through at least one of merchant information pages and service provider information pages within the mall which are at least partially co-branded with the affiliate, comprises the steps of: receiving a request from the affiliate for a mall web site that provides access to the at least one of the merchant web sites and service provider web sites through the at least one of the merchant information pages and service provider information pages; generating the mall web site; providing the affiliate with administrative access to the mall web site; and providing credit to the affiliate for revenue generating activities conducted at the at least one of the merchant web sites and service provider web sites as a result of access of the at least one of the merchant web sites and service provider web sites though the at least one of the merchant information pages and service provider information pages provided at the mall web site.

In at least one embodiment, the step of receiving a request from the affiliate comprises receiving from the affiliate information regarding one or more of the following: a name of the mall, a URL for the mall, an affiliate logo, the affiliate's identifying information, and a list of merchants to be included in the mall.

In at least one embodiment, the step of providing administrative access to the mall web site comprises providing the affiliate with a login ID.

In at least one embodiment, the step of generating a mall web site comprises providing a search engine that allows shoppers to search for at least one of merchants, products and services in the mall.

In at least one embodiment, the step of generating a mall web site comprises providing coupons, discounts, information and offers to shoppers for display and use on the merchant information pages and service provider information pages.

In at least one embodiment, the step of providing credit to the affiliate comprises tracking user site activity.

In at least one embodiment, the tracked user site activity is access to merchant web sites and service provider web sites through the merchant information pages and service provider information pages.

In at least one embodiment, the user site activity is tracked using an internal tracking server.

In at least one embodiment, the user site activity is tracked using an external third-party tracking server.

In at least one embodiment, the user site activity is tracked using a server of the merchant or service provider providing credit.

According to an exemplary embodiment of the present invention, a computer readable medium has computer executable instructions for performing a method for providing an Internet-based mall portal for an affiliate that provides access to at least one of merchant web sites and service provider web sites, where the merchant web sites and the service provider web sites are accessible through at least one of merchant information pages and service provider information pages within the mall which are at least partially co-branded with the affiliate, the method comprising: receiving a request from the affiliate for a mall web site that provides access to the merchant web sites and the service provider web sites; generating the mall web site; providing the affiliate with administrative access to the mall web site; and providing credit to the affiliate for revenue generating activities conducted at the merchant web sites and service provider web sites as a result of access of the merchant web sites and service provider web sites though the merchant information pages and service provider information pages provided at the mall web site.

According to an exemplary embodiment of the present invention, a system for providing an Internet-based mall portal for an affiliate that provides access to at least one of merchant web sites and service provider web sites through at least one of merchant information pages and service provider information pages within the mall which are at least partially co-branded with the affiliate, comprises: a mall portal request system that receives a request from the affiliate for a mall web site that provides access to the merchant web pages and the service provider web pages; a mall web site generator that generates a mall web site based on the request received by the mall portal request processor; a mall portal access system that provides the affiliate with administrative access to the mall web site; and an affiliate credit system that provides credit to the affiliate for site user activities.

In at least one embodiment, the site user activities comprises activities that generate revenue as a result of access of the merchant web sites and service provider web sites though the merchant information pages and service provider information pages provided at the mall web site.

In at least one embodiment, the revenue generating activities comprise one or more of the following: cost per thousand impressions (CPM) ad revenue, cost per click (CPC) ad revenue and commission on purchase of merchandise or services at the merchant web sites and service provider web sites.

In at least one embodiment, a computer system for providing an Internet-based mall portal for an affiliate that provides access to at least one of merchant web sites and service provider web sites through at least one of merchant information pages and service provider information pages within the mall which are at least partially co-branded with the affiliate, comprises at least one processor, and a computer-readable memory operatively connected to the at least one processor, with instructions capable of performing steps comprising: receiving a request from the affiliate for a mall web site that provides access to the merchant web sites and the service provider web sites; generating the mall web site; providing the affiliate with administrative access to the mall web site; and providing credit to the affiliate for revenue generating activities conducted at the merchant web sites and service provider web sites as a result of access of the merchant web sites and service provider web sites though the merchant information pages and service provider information pages provided at the mall web site.

These and other features of this invention are described in, or are apparent from, the following detailed description of various exemplary embodiments of this invention.

### BRIEF DESCRIPTION OF THE DRAWINGS

Various exemplary embodiments of this invention will be described in detail, with reference to the following figures, wherein:

FIG. 1 is a network diagram of a system for providing a web-based mall portal according to an exemplary embodiment of the present invention;

FIG. 2 shows pages from a mall portal according to an exemplary embodiment of the present invention;

FIG. 3 is a flowchart showing a method for providing a web-based mall portal according to an exemplary embodiment of the present invention; and

FIG. 4 is a block diagram showing a system for generating a web-based mall portal according to an exemplary embodiment of the present invention.

### DETAILED DESCRIPTION OF PREFERRED EMBODIMENTS

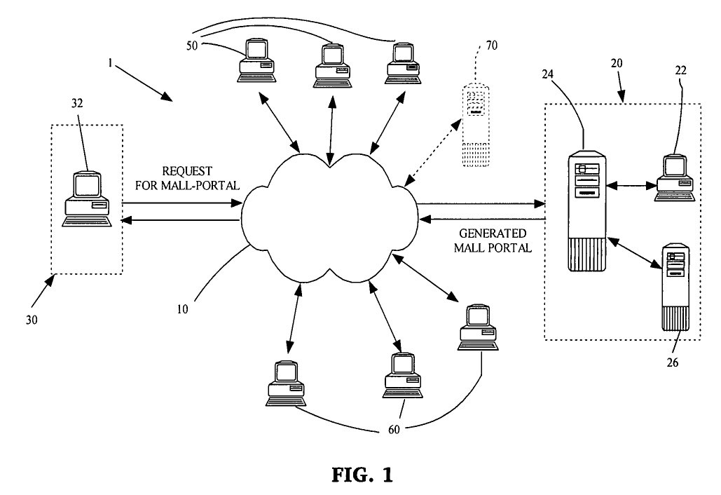

FIG. 1 is a network diagram of a system for providing a web-based mall portal, generally designated as reference number 1, according to an exemplary embodiment of the present invention. The system 1 may function through a network 10, such as, for example, the Internet, a wide area network (WAN) or a local area network (LAN). The system 1 includes a mall portal provider system, generally designated by reference number 20, and an affiliate system, generally designated by reference number 30. The mall portal provider system 20 includes a mall portal provider database 22 and a mall portal server 24. The affiliate system 30 includes an affiliate workstation 32. As explained in further detail below, the mall portal provider system 20 generates a mall portal for the affiliate system 30 at the affiliate's request, and the mall portal is provided to one or more client computers 50 over the network 10. Customers working in the client computers 50 are provided access to one or more merchants/service providers 60 through the mall portal operating on the mall portal server 24.

An affiliate may wish to operate a mall portal that provides potential customers with access to the one or more merchants/service providers 60, and receive credit for revenue generating activities performed by the customers when dealing with the merchants/service providers. In the system 1, the affiliate may make a request through the affiliate system 30 over the network 10 to the mall portal provider system 20 for a mall portal. The request may include specific requirements for the mall portal. For example, the affiliate may only want to be associated with merchants/service providers 60 that provide goods and/or services related to a specific category, such as, for example, electronics, clothing or music, or simply prefer specific merchants. In this regard, the affiliate's request may include information regarding preferences for the affiliate mall portal, such as the affiliate's brand to be used as the mall logo, a proposed URL for the mall, a list of merchants to be associated with the mall portal and associated network addresses (i.e., links), and a selected design for the mall portal site. The affiliate's request may also include information regarding payment details for the affiliate for revenue generating activities conducted at the individual merchants/service providers' websites. Further, the affiliate may select design options for the mall portal from a pre-defined list of options available from the mall portal provider system 20. For example, the mall portal provider system 20 may provide a checklist of available merchants/service providers, from which the affiliate may choose for inclusion in the mall portal.

Upon receipt of a request for a mall portal from the affiliate system 30, the mall portal provider system 20 may generate the mall portal using the request data input by the affiliate at the affiliate system 30 along with any other necessary data that may be input at the mall portal provider workstation 22 or via the network from the affiliate workstation 32. The generated mall portal preferably includes one or more main pages, including a “home page”, branded with the affiliate's logo or in lieu of a logo a text treatment of the affiliate name, and one or more merchant/service provider pages branded with the merchant/service provider logo and co-branded with the affiliate's logo or text name. The mall portal provider may allow the affiliate to access the mall portal administrative interface through, for example, a login ID, password or other key input. Thus, for example, the affiliate may be provided with at least some administrator privileges that allow the affiliate to modify the design or merchants/service providers of the mall portal.

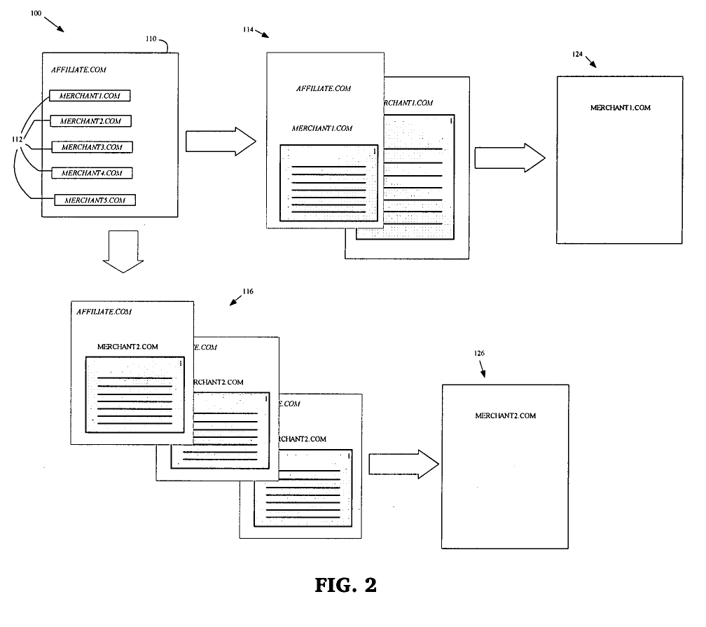

FIG. 2 shows a number of pages from a mall portal, generally designated by reference number 100, according to an exemplary embodiment of the present invention. The mall portal 100 includes a main page 110, which is shown branded with the affiliate's logo, “AFFILIATE.COM”. The main page 110 may include a plurality of links 112 to a variety of merchants/service provider information pages 114, 116. By clicking on one of the links 112, a customer is provided with access to associated merchant/service provider information pages, such as the merchant/service provider information pages 114, 116 shown in FIG. 2. The merchant/service provider information pages 114, 116 are branded with the merchant's logo, “MERCHANT1” on page 114 and “MERCHANT2” on page 116, as well as the affiliate's logo, “AFFILIATE.COM”. The merchant/service provider pages may be partially co-branded with the affiliate logo, as shown one page 114, or completely co-branded with the affiliate text identification, as shown on page 116. Form the merchant/service provider information pages, a customer is provided access to the service provider or merchant sites 124, 126 through graphical or textual navigation options.

As previously discussed, the affiliate may wish to receive credit for revenue generating activities conducted on the at least partially co-branded merchant/service provider information pages, or the merchant/service provider sites. Credit may then be given to the affiliate based on any revenue generating activities tracked at the merchant/service provider sites, such as, for example, ad revenue or purchase of goods or services at the merchant/service provider sites. The amount of credit that the affiliate receives for each revenue generating activity at each merchant/service provider site may be based on the pre-defined credit amount previously provided to the affiliate as a result of the original request for the mall. Tracking of revenue generating activities at the merchant/service provider sites may be performed by a third-party tracking server 70, or by the merchants/service providers themselves. Tracking information may be consolidated and available to the affiliate through administrative access to the portal server 24.

To increase the amount of revenue generating activities at the merchant/service provider sites, special offers, such as coupons or discounts, may be provided to customers at the merchant/service provider information pages. The special offers may only be provided to customers when purchasing goods/services through the mall portal, so that customers will favor the mall portal when shopping over the Internet, for example. The special offers may be provided at the mall portal main pages and/or at the at least partially co-branded merchant/service provider information pages.

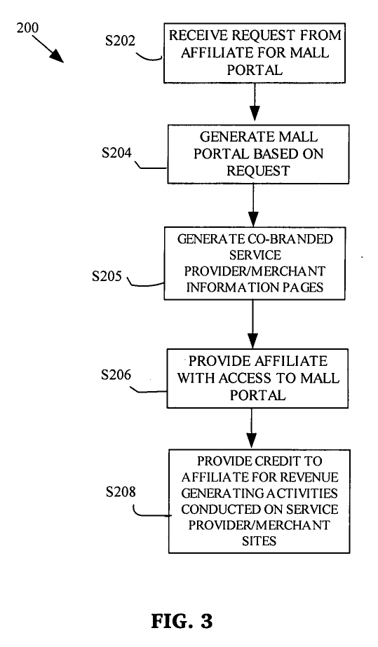

FIG. 3 is a flowchart of a method for providing a mall portal, generally designated by reference number 200, according to an exemplary embodiment of the present invention. In step S202 of the method 200, a request for a mall portal is sent from an affiliate to a mall portal provider. The request may be made over the Internet via http, instant message, e-mail, or by any other suitable communication means. The request may include information regarding the affiliate's preferences for the mall portal, such as, for example, the affiliate's brand to be used as the mall logo, a proposed URL for the mall, and a list of preferred service providers/merchants.

In step S204, the mall portal provider generates a mall portal based on the affiliate's request. The generated mall portal may include a search engine that allows customers to search for service providers/merchants using search terms. The mall portal may also include a browse feature which lists service providers/merchants based on merchandise or service category.

In step 205, the mall portal provider generates, as part of the mall portal, merchant/service provider information pages, which include at least one page which is branded with the service provider/merchant logo, as well as the affiliate logo (or text identification in lieu of logo). The merchant/service provider information pages provide access to the preferred merchant/service provider web sites.

In step S206, the mall portal provider provides the affiliate with access to the mall portal by, for example, assigning the affiliate a password or login ID. In step S206, the affiliate may use administrator privileges to select merchants in order to provide site visitors with special offers, such as coupons or discounts, at the at least partially co-branded service provider/merchant sites. The affiliate may make other changes or additions to the co-branded pages within the limits defined by the administrator privileges provided by the mall portal provider. Alternatively, the special offers may be included in the mall portal as presented to the mall site visitor by the mall portal provider based on default settings where offers are provided automatically to all participating affiliates.

In step S208, credit is provided to the affiliate for revenue generating activities performed by customers at the service provider/merchant sites as a result of their visits to the at least partially co-branded service provider/merchant pages within the mall. In this regard, an external tracking server 70 may be employed to track purchases at the service provider/merchants sites after a customer has accessed the service provider/merchant sites through the mall portal.

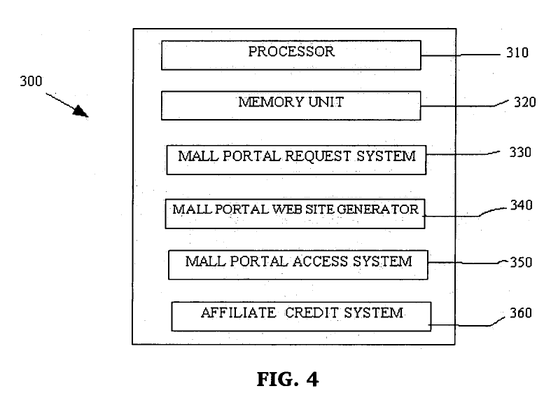

FIG. 4 is a block diagram showing a computer-based system for generating a network-based mall portal, generally designated by reference number 300, according to an exemplary embodiment of the present invention. The system 300 includes a processor 310, a memory unit 320, a mall portal request system 330, a mall portal web site generator 340, a mall portal access system 350 and an affiliate credit system 360. The components of the system 300 may form one or more components of software running through the processor 310 on a general-purpose computer system, one or more hardware components, or a combination of hardware and software components.

The mall portal request system 330 receives a request from an affiliate for a mall web site that provides access to at least partially co-branded merchant information web pages and service provider information web pages. The mall portal request system 330 processes the information received from the affiliate regarding the various features of the requested mall portal, such as, for example, the affiliate logo and merchant/service provider information. In an exemplary embodiment of the invention, the mall portal request system 330 may maintain a database containing information on the one or more affiliate mall portals.

The mall portal web site generator 340 generates a mall portal web site using the data processed by the mall portal request system 330. The generated mall portal preferably includes one or more information web pages that are branded both by the merchant/service provider logos as well as the affiliate logo.

The mall portal access system 350 regulates affiliate access of the mall portal web site by, for example, assigning a password or logon ID to the affiliate. The mall portal access system 350 may also include information regarding the administrator privileges of the affiliate to define the affiliate's ability to modify the mall portal web site.

The affiliate credit system 360 manages credit provided to the affiliates for revenue generating activities conducted by customers at the merchant/service provider web sites. For example, the affiliate credit system 360 may include a tracking server that tracks customer access to the merchant/service provider web sites through the mall portal, or may maintain information regarding such tracking retrieved by a third-party tracking server.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A method for providing an Internet-based mall portal for an affiliate that provides access to at least one of merchant web sites and service provider web sites through at least one of merchant information pages and service provider information pages, the merchant information pages and the service provider information pages being at least partially co-branded with the affiliate, comprising:
receiving a request from the affiliate for a mall web site that provides access to the merchant web pages and the service provider web pages;
generating the mall web site;
providing the affiliate with administrative access to the mall web site; and
providing credit to the affiliate for revenue generating activities conducted at the merchant web sites and service provider web sites as a result of access of the merchant web sites and service provider web sites though the merchant information pages and service provider information pages provided at the mall web site.

2. The method of claim 1, wherein the step of receiving a request from the affiliate comprises receiving from the affiliate information regarding one or more of the following: a name of the mall, a URL for the mall, an affiliate logo, the affiliate's identifying information, and a list of merchants to be included in the mall.

3. The method of claim 1, wherein the step of providing access to the mall web page comprises providing the affiliate with a login ID.

4. The method of claim 1, wherein the step of generating a mall web page comprises providing a search engine that allows shoppers to search for at least one of merchants, products and services in the mall.

5. The method of claim 1, wherein the step of generating a mall web page comprises providing coupons, discounts, information and offers to shoppers for display and use on the merchant information pages.

6. The method of claim 1, wherein the step of providing credit to the affiliate comprises tracking user site activity.

7. The method of claim 6, wherein the tracked user site activity is user access to the merchant web sites and service provider web sites.

8. The method of claim 6, wherein the user site activity is tracked using an external tracking server.

9. The method of claim 6, wherein the user site activity is tracked using a third-party tracking server.

10. The method of claim 6, wherein the user site activity is tracked using a tracking server located at at least one of the merchant web sites and service provider web sites.

11. A computer readable medium having computer executable instructions for performing a method for providing an Internet-based mall portal for an affiliate that provides access to at least one of merchant web sites and service provider web sites through at least one of merchant information pages and service provider information pages, the merchant information pages and the service provider information pages being at least partially co-branded with the affiliate, the method comprising:
receiving a request from the affiliate for a mall web site that provides access to the merchant information pages and the service provider information pages;
generating the mall web site;
providing the affiliate with administrative access to the mall web site; and
providing credit to the affiliate for revenue generating activities conducted at the merchant web sites and service provider web sites as a result of access of the merchant web sites and service provider web sites though the merchant information pages and service provider information pages provided at the mall web site.

12. The computer readable medium of claim 11, wherein the step of receiving a request from the affiliate comprises receiving from the affiliate information regarding one or more of the following: a name of the mall, a URL for the mall, an affiliate logo, the affiliate's identifying information, and a list of merchants to be included in the mall.

13. The computer readable medium of claim 11, wherein the step of providing access to the mall web page comprises providing the affiliate with a login ID.

14. The computer readable medium of claim 11, wherein the step of generating a mall web page comprises providing a search engine that allows shoppers to search for at least one of merchants, products and services in the mall.

15. The computer readable medium of claim 11, wherein the step of generating a mall web page comprises providing coupons, discounts, information and offers to shoppers for display and use on the merchant web pages.

16. The computer readable medium of claim 11, wherein the step of providing credit to the affiliate comprises tracking user site activity.

17. The computer readable medium of claim 16, wherein the tracked user site activity is user access to the merchant web sites and service provider web sites.

18. The computer readable medium of claim 16, wherein the user site activity is tracked using an external tracking server.

19. The computer readable medium of claim 16, wherein the user site activity is tracked using a third-party tracking server.

20. The computer readable medium of claim 16, wherein the user site activity is tracked using a tracking server located at at least one of the merchant web sites and service provider web sites.

21. A system for providing an Internet-based mall portal for an affiliate that provides access to at least one of merchant web sites and service provider web sites through at least one of merchant information pages and service provider information pages, the merchant information pages and the service provider information pages being at least partially co-branded with the affiliate, comprising:
a mall portal request system that receives a request from the affiliate for a mall web site that provides access to the merchant information pages and the service provider information pages;
a mall web site generator that generates a mall web site based on the request received by the mall portal request processor;
a mall portal access system that provides the affiliate with administrative access to the mall web site; and
an affiliate credit system that provides credit to the affiliate for revenue generating activities conducted at the merchant web sites and service provider web sites as a result of access of the merchant web sites and service provider web sites though the merchant information pages and service provider information pages provided at the mall web site.

22. The system of claim 21, wherein the site user activities comprise activities that generate revenue as a result of access of the merchant web sites and service provider web sites though the merchant information pages and service provider information pages provided at the mall web site.

23. The system of claim 22, wherein the revenue generating activities comprise one or more of the following: cost per thousand impressions (CPM) ad revenue, cost per click (CPC) ad revenue and purchase of merchandise or services at the merchant web sites and service provider web sites.

24. A computer system for providing an Internet-based mall portal for an affiliate that provides access to at least one of merchant web sites and service provider web sites through at least one of merchant information pages and service provider information pages, the merchant information pages and the service provider information pages being at least partially co-branded with the affiliate, comprising:
at least one processor; and
a computer-readable memory operatively connected to the at least one processor, with instructions capable of performing steps comprising:
receiving a request from the affiliate for a mall web site that provides access to the merchant web sites and the service provider web sites through the merchant information pages and service provider information pages;
generating the mall web site;
providing the affiliate with administrative access to the mall web site; and
providing credit to the affiliate for revenue generating activities conducted at the merchant web sites and service provider web sites as a result of access of the merchant web sites and service provider web sites though the merchant information pages and service provider information pages provided at the mall web site.

25. The computer system of claim 24, wherein the step of receiving a request from the affiliate comprises receiving from the affiliate information regarding one or more of the following: a name of the mall, a URL for the mall, an affiliate logo, the affiliate's identifying information, and a list of merchants to be included in the mall.

26. The computer system of claim 24, wherein the step of providing administrative access to the mall web page comprises providing the affiliate with a login ID.

27. The computer system of claim 24, wherein the step of generating a mall web page comprises providing a search engine that allows shoppers to search for at least one of merchants, products and services in the mall.

28. The computer system of claim 24, wherein the step of generating a mall web page comprises providing coupons, discounts, information and offers to shoppers for display and use on the merchant information pages and service provider information pages.

29. The computer system of claim 24, wherein the step of providing credit to the affiliate comprises tracking user site activity.

30. The computer system of claim 29, wherein the tracked user site activity is user access to the merchant web sites and service provider web sites.

31. The computer system of claim 29, wherein the user site activity is tracked using an external tracking server.

32. The computer system of claim 29, wherein the user site activity is tracked using a third-party tracking server.

33. The computer system of claim 29, wherein the user site activity is tracked using a tracking server located at at least one of the merchant web sites and service provider web sites.
